(19) United States
(12) Patent Application Publication
(10) Pub. No.: US 2008/0070098 A1
(43) Pub. Date: Mar. 20, 2008

(54) ELECTROCHEMICAL CELL AND CURRENT COLLECTOR ASSEMBLY THEREFOR

(76) Inventors: Robert E. Ray, JR., Strongsville, OH (US); Ning Cui, Lyndhurst, OH (US); Dawn Marie Lisowski, Cleveland, OH (US)

Correspondence Address: MICHAEL C. POPHAL;EVEREADY BATTERY COMPANY INC, 25225 DETROIT ROAD, P O BOX 450777, WESTLAKE, OH, 44145, US

(21) Appl. No.: 11/865,394

(22) Filed: Oct. 1, 2007

Related U.S. Application Data
(63) Continuation-in-part of application No. 11/496,679, filed on Jul. 31, 2006.

(51) Int. Cl. H01M 2/12

(52) U.S. Cl. 429/53

(57) ABSTRACT

Electrochemical cells, and particularly a current collector assembly for a cell that forms an electrically conductive path between a cell electrode and a terminal of the cell, are described, along with a method for manufacturing the same. The current collector includes a non-conductive core and a conductive outer surface layer disposed on the core and shaped as en elongated rod. A seal hub gasket for sealing the open end of a cell container and for venting gasses when exposed to excessive pressure is also described. The current collector includes a first diameter portion and a reduced second diameter portion, wherein the first diameter portion engages the seal in a non-vented state and during high pressure venting the seal moves relative to the current collector toward the second reduced diameter portion to allow venting of high pressure gases.

### CROSS-REFERENCE TO RELATED APPLICATION

This application is a continuation-in-part of U.S. application Ser. No. 11/496,679 entitled “NAIL-TYPE CURRENT COLLECTOR WITH NON-CONDUCTIVE CORE AND SURFACE METALLIZATION FOR ELECTROCHEMICAL CELL,” filed on Jul. 31, 2006, the entire disclosure of which is hereby incorporated herein by reference.

### FIELD OF INVENTION

The present invention relates to electrochemical cells, particularly to a current collector for a cell that forms an electrically conductive path between a cell electrode and a terminal of the cell. The invention also relates to a seal assembly including the current collector and a seal for sealing the open end of a cell container and for venting gasses when exposed to excessive pressure. In a preferred embodiment, the cell is an alkaline cell and the current collector electrically connects the cell negative electrode to a negative terminal. Methods for preparing a current collector are disclosed.

### BACKGROUND OF THE INVENTION

Conventional alkaline electrochemical cells generally include a steel cylindrical can having a positive electrode, referred to as the cathode, which commonly comprises manganese dioxide as the active material. The electrochemical cell also includes a negative electrode, referred to as the anode, which commonly comprises zinc powder as the active material. In bobbin-type or nail-type cells, the cathode is typically formed against the interior surface of the steel can, while the anode is generally centrally disposed in the can. A separator is located between the anode and the cathode, and an alkaline electrolyte solution simultaneously contacts the anode, the cathode, and the separator. A conductive current collector is inserted into the anode active material to provide an electrical path to a negative outer terminal. An annular polymeric (e.g., nylon) seal provides closure to the open end of the steel can to seal the active electrochemical materials in the sealed volume of the can. An inner cover radially supports the seal. The current collector, inner cover, and seal are typically assembled together to form a seal assembly.

The current collector must be conductive and provide an electrical path to a terminal. Accordingly, most battery manufacturers today rely upon current collectors made from metal or metal alloys, such as copper or brass. Usually, these metallic collectors have been plated with additional conductive materials. Ultimately, the material chosen for the current collector must exhibit adequate conductivity, minimize gassing, possess adequate durability to maximize shelf life of the cell and sufficient durability and non-reactivity when exposed to other internal components of the cell, such as the anode gel and the alkaline electrolyte.

However, previous metal and metal alloy current collectors suffer from numerous drawbacks. High costs for materials such as copper, have increased overall manufacturing costs for battery manufacturers. Moreover, solid metal and metal alloy parts tend to add unwanted weight to the overall cell. Lastly, metal current collectors perform poorly, in terms of gassing and leakage, as the cell is discharged and particularly under deep discharge conditions. Thus, various approaches have been taken to create a current collector with improved performance and reduced corrosion.

U.S. Pat. No. 6,783,895 to Imai et al. teaches a hydrophilic collector for alkaline secondary batteries formed of a nonwoven fabric plated with nickel. The nickel plated nonwoven fabric is hydrophilized by sulfonation, a gaseous fluorine treatment, or vinyl monomer grafting, and a method for making the collector by hydrophilizing a nonwoven fabric having polyolefin and polyamide fibers, followed by nickel plating, is disclosed. However, the collector disclosed expressly facilitates assembly of secondary batteries wherein porosity of the nickel plate is necessary to allow for increased cell capacity, and the nonwoven fabric has a plurality of micropores extending from one surface to the other surface thereof.

U.S. Pat. No. 5,423,974 to St-Amant et al. discloses a scheme to metallize at least one face of a plastic film under vacuum followed by electrochemical plating to provide a uniform, electrically conductive material. The thin metallic sheet obtained is adherent to and supported by the plastic film, which find use as, inter alia, current collectors for polymer electrolyte lithium batteries. However, this approach requires multiple, complex manufacturing steps, including the use of a vacuum.

Japanese Patent No. 63108666 to Toshiba Battery Co. teaches reducing deterioration in electric performance caused by the corrosion in a current collector. Specifically, the surface of a conductive plastic which is in contact with the positive electrode is coated with carbon-based conductive paint.

Japanese Patent No. 62126548 to Toshiba Battery Co. relates to use of a conductive plastic as a cathode current collector. Specifically, a thin metal layer is formed in the center of one side of the collector, and a cathode lead is then connected to this metal layer.

In view of the foregoing, a current collector and combination current collector assembly design suited for use in a bobbin-type cell would be welcomed. More specifically, a rod-shaped collector manufactured according to simple procedures and made from light-weight and inexpensive materials is needed.

### SUMMARY OF INVENTION

According to one aspect of the present invention, an electrochemical cell is provided that includes a current collector assembly that vents high pressure gases, is cost-effective, has a low profile and is easy to assemble. The electrochemical cell includes a container having an open end and at least one contact terminal, and positive and negative electrodes disposed within the container. The electrochemical cell further includes a current collector and seal assembly having a seal and a current collector. The seal is disposed in the open end of the container and has an opening. The electrochemical cell further includes a current collector including an elongate member extending through the opening in the seal and disposed in contact with one of the positive and negative electrodes. The current collector has a non-conductive core and an electrically conductive outer surface. The elongate member has a first diameter portion sealingly engaging the opening in the seal in a non-vented state and further has a smaller second diameter portion configured to allow the seal to vent when exposed to an excessive pressure differential such that the seal moves relative to the current collector from a sealed engagement with the first diameter portion to a venting arrangement with the second diameter portion to vent high pressure gases.

According to another aspect of the present invention, a ventable current collector assembly is provided for an electrochemical cell. The current collector assembly includes a seal adapted to be disposed in an open end of a cell container and having an opening extending therethrough. The assembly also includes a current collector comprising an elongate member extending through the opening in the seal and adapted to be disposed in contact with a cell electrode. The current collector has a non-conductive core and an electrically conductive outer surface. The elongate member has a first diameter portion sealingly engaging the opening in the seal in a non-vented state and a smaller second diameter portion configured to allow the seal to vent when exposed to an excessive pressure differential such that the seal moves relative to the current collector from a sealed engagement with the first diameter portion to a venting arrangement with the second diameter portion to vent high pressure gases from a cell.

These and other features, advantages and objects of the present invention will be further understood and appreciated by those skilled in the art by reference to the following specification, claims and appended drawings.

### BRIEF DESCRIPTION OF DRAWINGS

The invention can be understood with reference to the following drawings. The components in the drawings are not necessarily to scale. Also, in the drawings, like reference numerals designate corresponding parts throughout the several views. In particular:

FIGS. 1a and 1b are, respectively speaking, vertical cross-sectional views through one embodiment of the rod-shaped current collector and the step-shaped current collector;

FIG. 2 is an exploded view through line A-A defined in FIG. 1 illustrating one embodiment of the possible conductive coating layers;

FIG. 3 is a graph demonstrating the optimal thickness for a conductive coating according to one embodiment of the invention against performance of a conventional cell for 400 mA and 1000 mA continuous drain tests;

FIG. 4 is a longitudinal cross-sectional view of one embodiment of an electrochemical cell having a current collector assembly according to one embodiment of the present invention;

FIG. 5 is a side elevational view of a current collector assembly for an electrochemical cell according to another embodiment of the present invention;

FIG. 6A is a side elevational view of a current collector assembly for an electrochemical cell according to another one embodiment of the present invention, and FIGS. 6B and 6C are top views of current collector heads illustrating one embodiment of a mated junction to maintain electrical contact between the container or contact terminal and the current collector assembly;

FIGS. 7-9 are, respectively speaking, graphical representations of data connected to Examples 1-3;

FIG. 10 is a partial exploded view of an electrochemical cell and its current collector assembly having an integral pressure relief mechanism, according to one embodiment of the present invention;

FIG. 11 is a partial cross-sectional view of the electrochemical cell employing the current collector assembly of FIG. 10 shown in the non-vented position;

FIG. 12 is a partial cross-sectional view of the electrochemical cell with the current collector assembly shown during high pressure gas venting; and

FIG. 13 is a partial cross-sectional view of the electrochemical cell illustrating the current collector assembly in the post vent position.

### DETAILED DESCRIPTION OF THE INVENTION

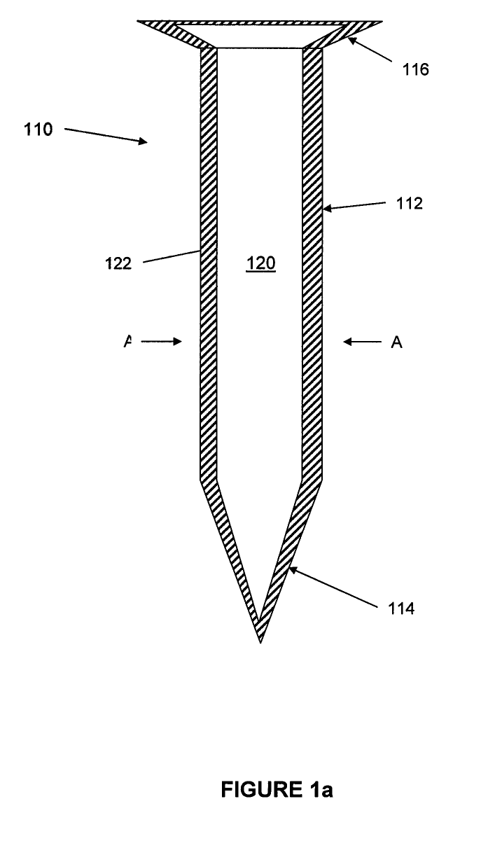

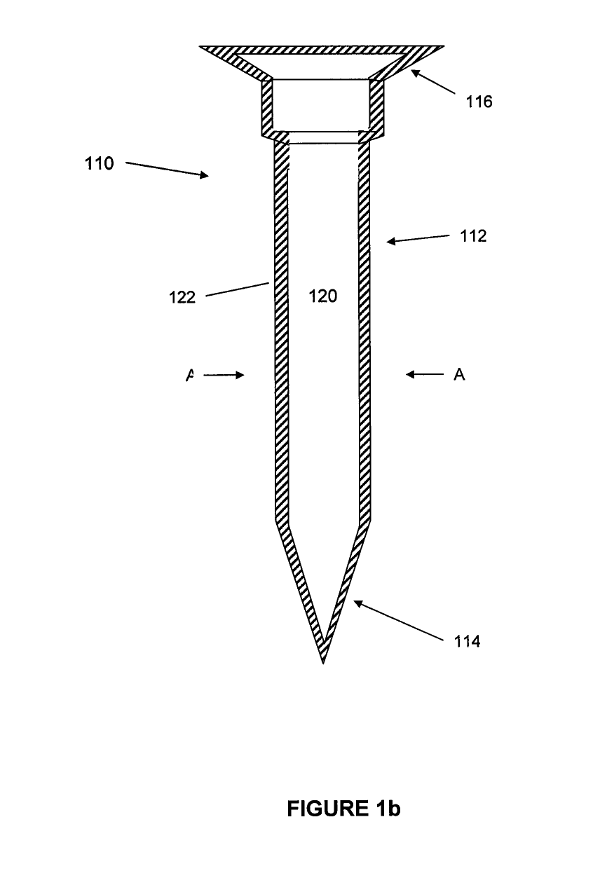

Referring now to the drawings, wherein the final two digits of the reference numerals refer to components or elements that are common to all the figures, FIG. 1 illustrates one embodiment of a current collector 10 of the present invention. Current collector 10 is adapted to provide a conductive path from a positive or negative electrode operatively to a terminal or cover of an electrochemical cell, which may be integrated with the container in some electrochemical cell designs. Current collector 10 is preferably utilized in a primary alkaline-type electrochemical cell and serves to operatively provide an electrical current path from a negative electrode to a negative terminal of the cell or another conductive member operatively electrically connected to the negative terminal.

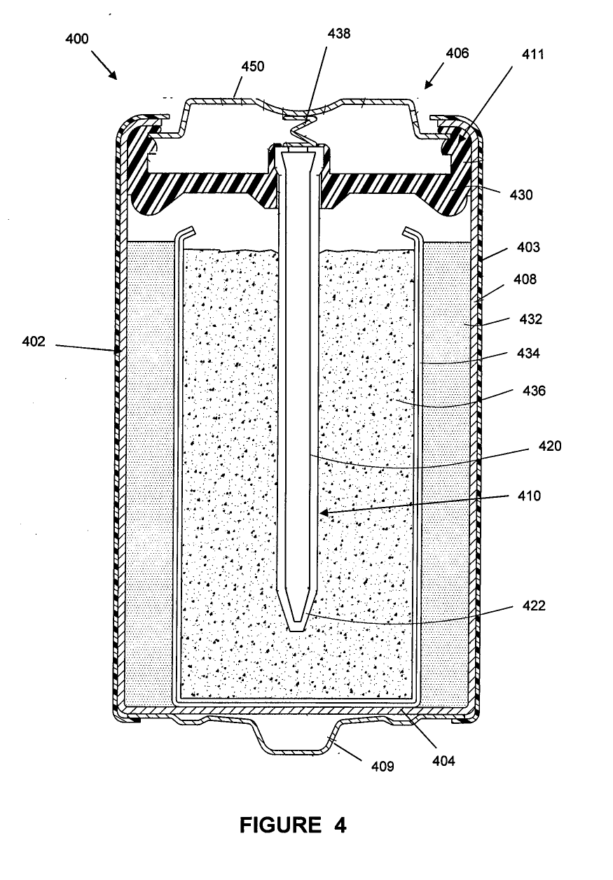

Current collector 10 is an elongated member in the shape of a rod, suitable for use in bobbin-type electrochemical cell designs. The rod may be a cylinder, preferably having a nail shape with a conical terminus on one end and an expanded flattened head on the opposing end. The cylinder may be of varied diameter (i.e. stepped and/or tapered) or uniform diameter (i.e., constant diameter or non-tapered). Other tubular shapes, aside from cylinders are also possible. By way of example rather than limitation, such shapes include triangular, square/rectangular or polygonal shape tubes having (respectively speaking) three, four or multiple essentially flat sides. Combinations incorporating one or more flat sides in conjunction with one or more curved sides are also possible. In each instance, the shape may be tapered or non-tapered and may incorporate a conical tip and/or a flattened head. Notably, tip can have generally any design and can, for example, have a conical end (as shown in FIGS. 1a and 1b), a truncated conical end (as shown in FIG. 4), a blunted end or the like.

As seen in FIG. 1a, current collector 110 necessarily includes a shaft 112. In one embodiment, shaft 112 has a substantially constant outer diameter and a conical end 114 is provided. Notably, the shaft must be of sufficient axial length to efficiently collect current from the electrode in contact with collector 110. In FIG. 1b, the shaft 112 has a stepped-outer diameter and a conical end. Here again, the shaft must be of sufficient axial length and diameter to efficiently collect current.

In both FIGS. 1a and 1b, the upper end of current collector 110 includes a head 116, which has an enlarged diameter but substantially smaller axial length as compared to shaft 112, so as to simplify manufacture of the current collector assembly designed below. That is, head 116 is generally larger in size than shaft 112 in order to maintain the current collector 110 in a desired position within a cell. Head 116 can have an outer surface that tapers along all or a part of the axial length thereof, measured in relation to the central axis of the current collector 110. The head 116 also tapers radially outward from where head 116 connects to shaft 112 to the upper end thereof, and the radial diameter may optimally match the radial diameter of the shaft 112 (e.g., circular, polygonal, irregular, etc.).

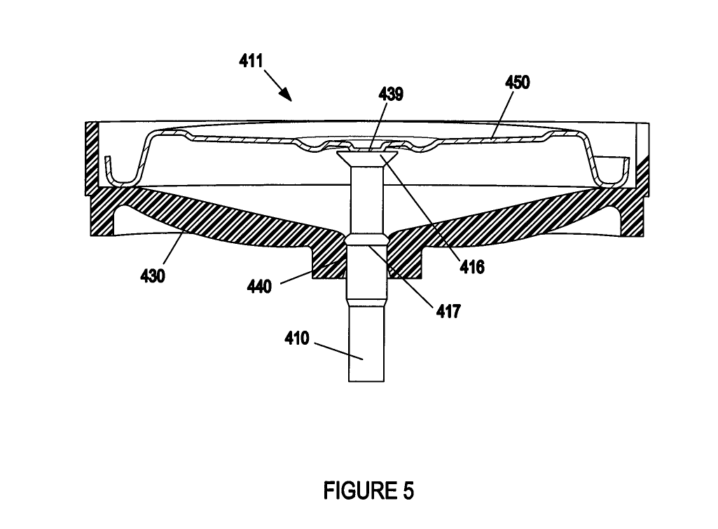

Other head designs can be free of a taper, or the head may include multiple radially offset segments forming one or more nubs near the end of the shaft in addition to or in place of the flattened terminus described above. These nubs may be sized to cooperate with a seal hub or gasket to hold the collector 110 in place. For example, with reference to FIG. 5, radial nub 417 works in conjunction with head 416 to securely hold the collector 410 in place inside of seal hub or gasket 430. Alternatively, such a radial nub can also be integrally provided as part of a stepped portion as contemplated in FIG. 1b.

Current collector 110 must be of a composite structure having at least two different layers, namely at least one conductive, non-carbonaceous layer 122 situated partially, if not completely, over a non-conductive core 120, preferably crafted from one or more polymers. Core 120 may be formed from a polymer or copolymer system via injection molding, thermoforming, extruding or other appropriate known methods. Core 120 should be solid and non-porous, although the surface need not be completely smooth. In fact, surface variations or roughness, including dimples, stippling, or the like, may be preferable in certain circumstances. Significantly, the core 120 must not be fabric, sheet, or film, whether woven or non-woven, as such sheets are easily included with the manufacturing processes contemplated for the bobbin-type cells contemplated herein. Core 120 provides the desired base structure for current collector 110 to which the non-carbonaceous conductive layer 122 is then applied.

Core 120 provides desirable strength, stiffness and impact resistance properties, in addition to being light in weight and cost effective by volume when compared to prior art metal current collectors, such as made from brass. The nonconductive material should also be chosen to have a low coefficient of thermal expansion and resistance to the alkaline electrolyte utilized in the cell.

As described hereinabove, the non-conductive core 120 is a polymer or copolymer that is/are either thermoplastic or thermosetting, with a synthetic thermoplastic polymer or copolymer being preferred. Examples for core layer 120 include, but are not limited to, acrylonitrile-butadiene-styrene copolymers (ABS), acetal resins (such as Delrin®, acrylic resins (such as nylon), fluorocarbon resins, epoxy resins, polyamide resins, liquid crystal polymers, polyphenyl oxides, polyphenyl sulfides, polyimides, polyether imides, polyvinyl chlorides, polyurethanes, polysulfones, polyolefins, polystyrenes, polyesters, polypropylenes, polyethylenes, polycarbonates and combinations thereof, as appropriate, optionally utilizing compatibilizers as known in the art. Plating grade ABS plastic, available from Diamond Polymers, Inc. at 1353 Exeter Road in Akron, Ohio, is preferred in forming core 120 in one embodiment of the present invention because of its superior surface finishing and adhesiveness to conductive layer 122.

As known to one of ordinary skill in the art, (co)polymers of the core layer can include various additives, fillers, or the like with filler examples including ceramic powders, glass spheres, wood flower, and sand. Other additives include, but are not limited to, stabilizers, plasticizers, lubricants, colorants, flame retardants, antioxidants, antistatics, preservatives, processing aids, smoke suppressants, and impact modifiers. As indicated, the core 120 is essentially free of any conductive components.

Core 120 can be fabricated utilizing a suitable device such as an injection molding device, thermoformer, or extruder. The most prevalent method for providing thermoplastic parts is injection molding, which is preferred in the present invention. Specifically, ABS resin needs to be dried to a level of 0.1% or less prior to molding, which is generally performed at 80°-85° C. in a desiccant dryer for 2-4 hours. ABS can be injected molded at the following preferred conditions: barrel temperature in the range of 220°-250° C., mold temperature between 40°-80° C., injection pressure ranging between 700-1100 psi and slower injection speed.

After the non-conductive core 120 has been formed into a desired shape, a conductive surface layer 122 is applied thereto, preferably forming a metallized layer on the surface of core 120. While conductive layer 122 can be applied to only a portion of the surface of core 120, the conductive layer 122 coverage on core 120 is generally selected to insure collector 110 is capable of handling all current flowing in the cell, and preferably 100% coverage of the core 120 is accomplished.

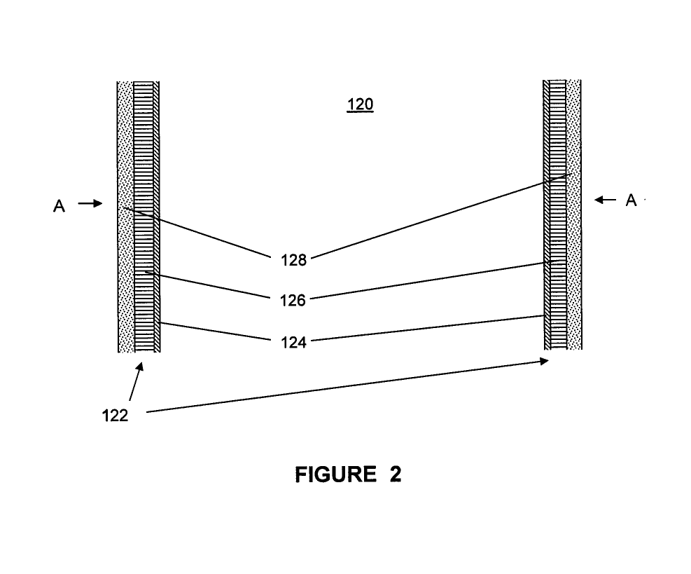

Conductive layer 122 comprises of one or more individual layers 124, 126, 128 that can be the same or different, as generally seen in FIG. 2. Conductive layer 122 can be formed on core 120 using a process such as electroless plating, chemical plating, electroplating, vacuum deposition or combinations thereof. In one embodiment, electroless plating followed by electroplating is utilized to form a plurality of conductive layers on core 120, wherein the layers may be the same or different materials. For example, the conductive layer 124 may comprise a layer of copper, provided at a thickness of at least 1.5 μm and more preferably at least 6.0 μm, with the copper provided by way of electroless plating followed by further electroplating of additional copper in layer 126. Other metal(s) then can be applied to collectively form conductive layer 128, including but are not limited to, copper, tin, zinc, indium, cadmium, lead and combinations and/or alloys thereof. Notably, non-carbonaceous materials are well suited for the objects and methods of this invention. Furthermore, it is believed the plating methods disclosed herein provide better adhesion of the metal to the non-conductive core as compared to previously known methods relying on carbon-based paints and the like.

The electroless plating step is accomplished without the use of electricity. The non-conductive core, such as an injected molded ABS nail sized for D cell, is placed in a bath solution including a reducing agent, such as 10 ml/L of formaldehyde, and the desired metal(s) in ionic form, such as 5 g/L of Copper sulfate. Electrons from the reducing agent work to deposit the metal ions onto the ABS nail in the presence of a catalyst, such as platinum. Use of other components such as complexing agents, pH modifying agents, buffers, stabilizers, etc. may further assist in the process. This process may be repeated multiple times in order to create multiple layers of deposited material. In such cases, deionized water can be used to rinse the part between platings, and the final plated nail should be dried prior to assembly of the electrochemical cell.

Prior to electroless plating, the core 120 can undergo numerous pretreatment processes, including but not limited to: cleaning, etching, neutralizing and activating. Additionally, to insure a satisfactory bond between the deposited metal/metal alloy 122 and the core 120, core 120 should be rinsed with deionized water or other suitable solvents between plating/conductive material deposition. Finally, the final collector 110 should be dried prior to use in the electrochemical cell.

The resulting plated rod will have a slightly rougher surface than the original core. For example, with copper electroless plated on an ABS core, the surface roughness may be anywhere from two to three times greater than either the ABS core alone or a typical brass nail (note that the ABS core and the brass nail have approximately the same surface roughness). Generally, the roughness tends to decrease as the thickness of the plating increases, as seen in Table 1 below.

TABLE 1
SURFACE ROUGHNESS MEASUREMENTS

| | |
|---|---|
| Brass nail | 0.25 μm |
| ABS core (no plating) | 0.27 μm |
| 1.5 μm thick Cu electroless plating | 0.86 μm |
| 4.3 μm thick Cu electroless/electroplated comb. | 0.68 μm |
| 7.5 μm thick Cu electroless/electroplated comb. | 0.60 μm |

FIG. 2 illustrates a cross section taken along line A-A from FIG. 1. Collector 110 having multiple layers of conductive material 124, 126, 128 deposited thereon. In one embodiment, a copper layer 126 is plated over a copper electroless layer 124, with a final layer 128 of a metal such as indium or tin plating on the outermost surface. The electrolytic plating can be performed utilizing a barrel plating device such as a lab scale barrel plater available from Sterling Systems at 3745 Stem Ave. in St. Charles, Ill., or a vibrating device.

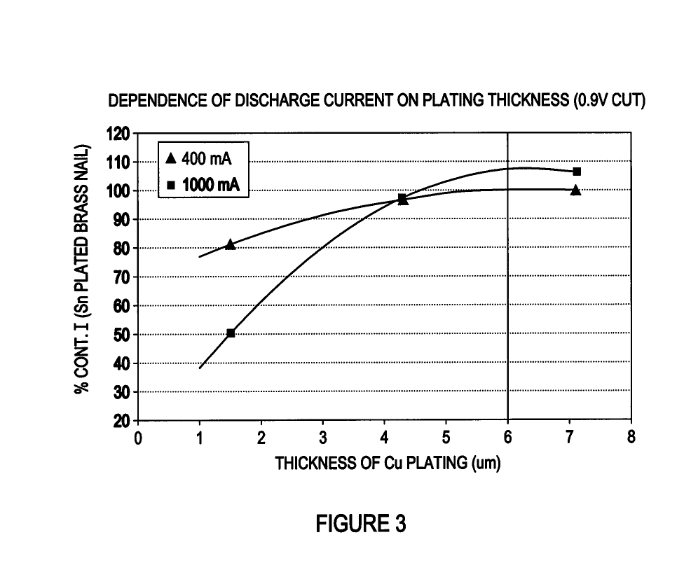

FIG. 3 shows experimental results for electrochemical cells made according to a preferred embodiment of the invention. Copper plating was provided to an ABS rod which was then incorporated into a C-sized battery. Additional control cells were made using a conventional brass nail, and the cells were service tested at a continuous 400 mA and 1000 mA drain rates. As indicated by the two curves, a point of diminishing returns (in terms of performance) for the present embodiment seems to be achieved at plating thicknesses in excess of 6 μm.

Current collectors of the present invention can be utilized in generally any electrochemical cell where needed, and are preferably utilized in any cylindrical alkaline electrochemical cells. Typical processes, constructions and materials for such cells are well known in the art. Accordingly, exemplary U.S. Pat. Nos. 6,528,210; 6,589,693; 6,670,073; and 6,828,061, all commonly assigned to the Eveready Battery Company are incorporated herein by reference for their teachings regarding such processes, constructions and materials.

A cylindrical alkaline electrochemical cell 400 is shown in FIG. 4 having a current collector 410 according to one embodiment of the present invention. Electrochemical cell 400 includes a cylindrical steel can 402 having a closed bottom end 404, an open top end 406, and a cylindrical axial side walls 408 extending there between. The closed bottom end 404 of can 402 has a positive cover welded or otherwise attached thereto and formed of plated steel, with a protruding contact terminal 409 at its center region. Assembled to the open top end 406 of steel can 402 is the current collector 410 and a collector assembly 411, and an outer negative cover 450, preferably formed of plated steel, which forms the negative contact terminal of cell 400. While a negative cover is contemplated in this example, it is possible to reverse the polarity of the cell (thereby imparting a positive polarity to cover 450, along with corresponding rearrangement of the electrodes) without departing from the principles disclosed herein.

A metallized, plastic film label 403 is formed about the exterior surface of steel can 402, except for the ends of steel can 404, 406. Film label 403 is formed over the peripheral edge of the positive cover and may extend partially over the peripheral edge of the negative cover 450.

A positive electrode 432, also referred to herein as the cathode, is formed about the interior surface of steel can 402. According to one example, the cathode 432 is formed of a mixture of manganese dioxide, graphite, potassium hydroxide solution, and additives. A separator 434, which is preferably formed of a non-woven fabric that prevents migration of any solid particles in the cell, is disposed about the interior surface of cathode 432. A negative electrode 436, also referred to herein as the anode 436, is disposed with an electrolyte inside the separator 434 and in contact with a current collector 410. The electrolyte may include an alkaline electrolyte containing aqueous potassium hydroxide (KOH). According to one example, the anode 436 is formed of zinc powder, a gelling agent, and additives. The manganese dioxide and zinc employed in the cathode 432 and anode 436, respectively, are electrochemically active materials. Accordingly, the cathode 432 is configured as the cell's positive electrode, and the anode 436 is configured as the cell's negative electrode.

The current collector 410 contacts the outer negative cover 450 which forms the negative contact terminal of cell 400. The elongated shaft is disposed in contact with the anode 436 and, in this embodiment, has a substantially uniform diameter. The current collector 410 is connected to the outer negative terminal 450 via a compressible coiled conductive connector 438 or other known means. The coiled connector 438 may be welded to the bottom surface of outer negative cover 450 and/or to the upper surface of enlarged head of current collector 410 or alternately may be held in contact therewith via pressure contact. Current collector 410 and connector 438 serve as an electrical current path to provide the negative polarity at the outer negative cover 450.

An annular polymeric seal 430 is disposed in the open end of steel can 402 to prevent leakage of electrochemically active cell materials contained in steel can 402. Polymeric seal 430 may comprise a synthetic thermoplastic resin such as nylon. Alternate materials for seal 430 may include polypropylene, such as NORYL® Extend which is commercially available from General Electric Company, and other materials that would be recognized as suitable for seal 430.

Seal 430 has a central hub with an inner upstanding cylindrical wall defining a central opening (i.e., aperture) for receiving the current collector 410. Hub is generally defined as the central portion of seal 430 containing upstanding wall which is compressed against the current collector 410. The enlarged head of current collector 410 is generally oversized for the hub opening, and thus the seal 430 is compressed against the current collector 410 to form an interference fit engagement with the inner upstanding wall defining the hub opening. The upstanding wall is configured to seal in the enlarged head of current collector 410 when in a sealed (non-vented) position and/or any radial nubs (not shown) that may be provided along the shaft of collector 410. The central hub also has an upper edge formed over the upper peripheral surface of enlarged head of collector 410 to further resist upward movement of current collector 410. An inner cover, which is preferably formed of a rigid metal, is provided to increase the rigidity and support the radial compression of annular seal 140, thereby improving the sealing effectiveness. The inner cover is configured to contact an outer upstanding wall of central hub and an upstanding wall at the outer peripheral section of seal 430. While an oversized current collector 410 and an inner cover are used to compress the seal 430 against the current collector 410, other compression techniques such as compression rings may be employed to provide a sealed interference fit engagement between the current collector 410 and seal 430. The seal 430, inner cover, and outer negative cover 450 provide a low profile closure to the open end 406 of can 402. In addition, the outer negative cover 450 also includes one or more vent openings (not shown) that serve to expose the non-sealed volume of cell 400 to the surrounding outside atmosphere. Vent openings serve to vent pressure build-up released from within the cell 400 to the outside atmosphere once the collector and seal assembly vents.

Together, the current collector 410, annular seal 430, and inner cover, if present, form the collector and seal assembly 411 which may be assembled together and inserted as a unit into the open end 406 of steel can 402. The assembly of the collector and seal assembly 411 and closure of the open end 406 of can 402 include disposing the annular polymeric seal 430 in the open end 406 of the can 402, which may have a flared opening or a bead formed radially inward on the inner wall of the can 402, and crimping the upper end of the can 402 inwardly and over the outer periphery of the seal 430 to compress the seal 430 against the inner cover. It should also be appreciated that the outer negative cover 450 is electrically insulated from the steel can 402 by way of annular polymeric seal 430.

According to the present invention, the current collector and seal assembly 411 seals closed the open end 406 of can 402, provides an electrical current path to the outer negative terminal 450, and further acts a pressure relief (vent) mechanism when exposed to an excessive pressure differential. The collector and seal assembly 411 is designed to release pressurized gases from within the sealed active volume of cell 400 when the assembly 411 is exposed to a predetermined pressure differential. The pressure differential is the difference between the internal pressure below the seal 430 and the atmospheric pressure above it. The pressurized gas venting is generally achieved by relative axial (i.e., parallel to a longitudinal axis of the current collector 410) movement between the current collector 410 and annular polymeric seal 430. The pressurized gases released from the internal volume exit cell 400 via openings (not shown) provided in the outer negative cover 450.

Examples of suitable seal assemblies are further set forth in U.S. Pat. Nos. 6,855,454 and 6,312,850, herein incorporated by reference. Other similar seals and vents can also be utilized with the current collector of the present invention.

A further embodiment of a seal assembly 411 including a current collector 410 of the present invention is set forth in FIG. 5. In the particular arrangement shown, seal assembly 411 includes a seal 430, formed of a material such as described hereinabove, preferably nylon. A current collector 410 of the present invention having a non-conductive core and a conductive outer surface such as described hereinabove, has a head portion 416 that extends through an orifice in seal 430. In one embodiment, a sealant, such as adhesive 440 such as Swift Adhesive #82996, or other similar blends, may be used to perfect the seal between current collector 410 to seal hub 430.

A portion of head 416 extends above seal 430 for appropriate connection to terminal 450 or another suitable contact terminal. Seal 430 preferably includes one or more thinned portions so as to allow for a venting mechanism.

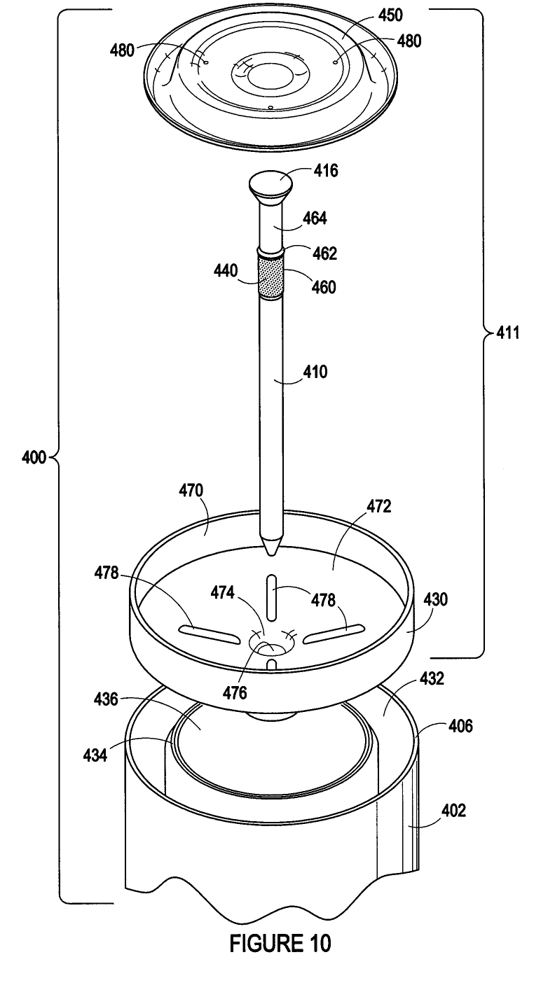

The embodiment of the current collector and seal assembly 411 shown in FIG. 5 is further illustrated in an exploded view in FIG. 10. The current collector 410 is shown having a generally elongate member in the general shape of a generally cylindrical rod with stepped surfaces configured to engage the seal 430 in vented and non-vented states. In particular, the elongate member of the current collector 410 includes a first diameter portion 460 which transitions to an enlarged diameter portion generally in the shape of an outward projecting barb 462. Above barb 462 is a second reduced diameter portion 464 which extends to the head 416. The barb 462 essentially provides an enlarged third diameter portion that is greater in diameter than the first diameter portion 460, and the first diameter portion 460 is greater in diameter than the second diameter portion 464. The first diameter portion 460 and barb 462 may be considered as a radial nub that is larger in diameter than other portions of the elongate member. The lowermost portion of the current collector is generally shown in a shape of a cylindrical rod that extends into contact with the negative electrode (anode) 436, according to the disclosed embodiment.

The seal 430 is generally shown as an annular seal or sealing gasket made up of an outer peripheral outstanding wall 470, a central hub 474, and an intermediate portion 472 extending between the hub 474 and upstanding wall 470. The upstanding wall 470 of the seal 430 is configured to engage the inner wall of the container 402 at the open end 406. During closing of container 402, the upstanding wall 470 of seal 430 is compressed during a crimping procedure to form a sealed closure to the open end 406 of container 402.

The hub 434 of seal 430 is generally shown as a central hub having an opening 476 formed centrally therein. The opening 476 is generally shaped and sized to receive the current collector 410 as described herein. Disposed between the current collector 410 and the opening 476 in the seal hub 474 is sealant 440 which enhances the leak performance of the cell 400 in the operative non-vented state.

The elongate member of the current collector 410 extends into the opening 474 of hub 476 of seal 430, prior to assembly into container 402, according to one embodiment. Additionally, the outer cover 450 that forms an electrical contact terminal is provided in electrical contact with the head 416 of current collector 410. According to the embodiment shown, the head 416 is welded or adhered via a conductive adhesive to the bottom surface of contact terminal 450. A suitable conductive adhesive may include a metal-filled epoxy based adhesive, such as silver powder or silver coated Cu or Ni powders filled with adhesives. Examples of such adhesives are Loctite® 3888 silver conductive adhesive, Master Bond EP21TDCS or EP77M-F, and SPI Silver Kwik-Stik™. It should be appreciated that the head 416 of current collector 410 may otherwise be electrically coupled to the contact terminal 450. Together, the contact terminal 450, current collector 410 and seal 430 are assembled to form a preassembled assembly as a unit which, in turn, may be disposed within the open end of container 402 which contains the positive and negative electrodes 432 and 436, separator 434, electrolyte and other components provided within the sealed volume of the container 402. Following insertion of the collector and seal assembly 411 into the open end of the container 402, the open end 406 of the container 402 is crimped over the peripheral portions of the contact terminal 450 so as to squeeze and compress the upstanding wall 470 of seal 430 to form a sealed closure to the container 402.

The electrochemical cell 400 is generally sealed closed in its normal operative non-vented state. The seal 430 and current collector 410 are configured to provide a sealed engagement in the non-vented state and to move relative to each to a vent position when an excessive pressure differential is experienced. Upon reaching an excessive pressure differential, the electrochemical cell 400 is designed to vent high pressure gases which are released from inside the sealed volume of the cell 400 by passing the vented gases between the current collector 410 and seal 430 and further passing the vented gases to the outside environment via vent holes 480 provided in the contact terminal 450.

The venting operation of the electrochemical cell 400 is further illustrated in FIGS. 11-13, according to one embodiment. As seen in FIG. 11, the seal 430 is positioned in sealed engagement with the current collector 410 in the operative non-vented state. In this state, the hub 474 of seal 430 sealingly engages the first diameter portion 460 of current collector 410. In this sealed position, the upper side of hub 474 of seal 430 may further engage the enhanced third diameter portion provided by barb 462. The first diameter portion 460 and enlarged diameter barb 462 retain the seal 430 in a sealed position relative to current collector 410 during normal pressure differentials. As pressure builds within the sealed volume of the electrochemical cell 400, the seal 430 will experience increased outward force which is resisted by the first diameter portion 460 and barb 462.

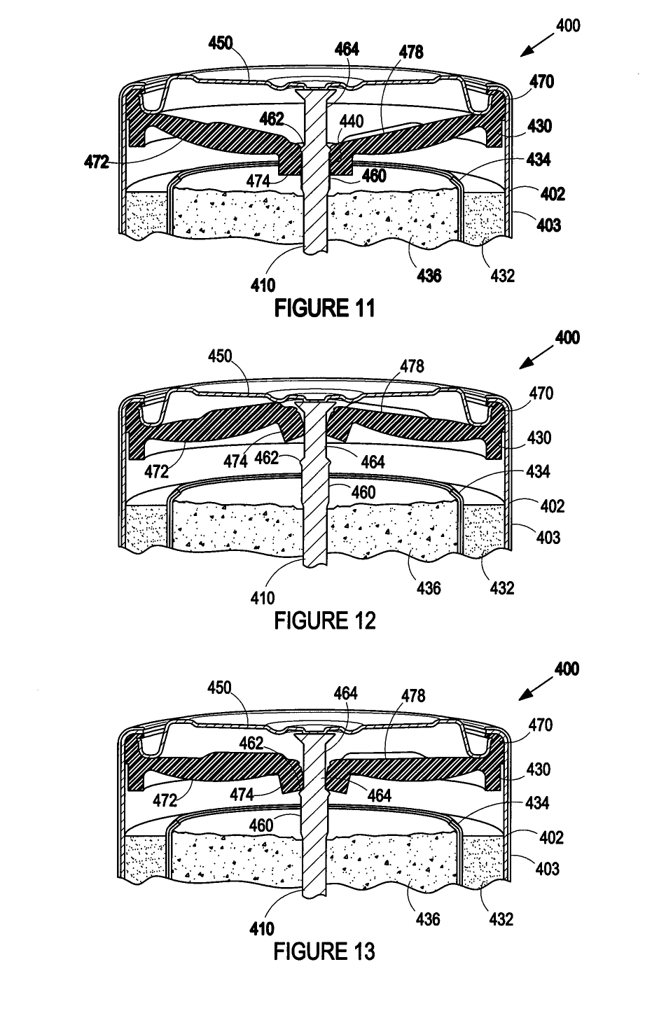

When the pressure within the sealed volume of the container 402 sufficiently increases such that an excessive pressure differential exists between the sealed volume pressure and the outside atmospheric pressure, the seal 430 is forced to move upward along the axial length of the elongate member such that the seal hub 474 is forced to slide upwards along the first diameter portion 460 and over the enlarged third diameter portion of barb 462 end into a vent position with the reduced second diameter portion 464. Due to the reduced diameter of first diameter portion 460 relative to the diameter of the seal hub opening 476, venting gases are able to pass between the current collector 410 and seal 430. As seen in FIG. 12, the seal 430 is forced to slide upward over barb 462 and may temporarily contact with the bottom surface of contact terminal 450 during the venting of high pressure gases. In order to prevent sealing of the seal 430 with the bottom surface of contact terminal 450, a non-planar interface surface is provided on at least one of the bottom surface of the contact terminal 450 and the top surface of the seal 430. In the embodiment shown, the top surface of the seal 430 is formed with one or more flutes 478, which are generally formed as depressions or grooves within the top surface of the intermediate portion 472 of seal 430. The flutes 478 provide a non-uniform or non-planar surface that allows vented gases to pass between the seal 430 and the bottom surface of contact terminal 450 during the high pressure venting operation. It should be appreciated that protrusions may be employed instead of recessed flutes 428 to prevent sealing between the seal 430 and outer contact terminal 450 during the venting operation.

Once the high pressure gases have sufficiently vented from within the cell container 402, the seal 430 may drop back downward due to its resilience. In doing so, the hub 474 of seal 430 may drop back down into engagement with an upper sloped surface of barb 462 so that the seal hub 470 generally remains in contact with the second reduced diameter portion 464 as seen in FIG. 13. It should be appreciated that once the electrochemical cell 10 is initially vented, the seal hub 474 may form a resealing of the seal 430 relative to current collector 410 in the post vent state to prevent further discharge of some cell materials. However, it should be appreciated that further venting may occur at a much lower pressure than the initial configured vent pressure.

Accordingly, the collector and seal assembly 411 illustrated in FIGS. 5 and 10-13 advantageously utilizes a current collector 410 having a non-conductive core and conductive coating in combination with a configuration that allows for venting between the seal hub 474 and the current collector 410, thus allowing for a low cost, low profile current collector and seal assembly which is easily assembled into an electrochemical cell 400. It should be appreciated that the shaped current collector 410 may be easily manufactured in a cost-effective manner by employing a non-conductive core which may be formed using injection molding followed by subsequent conductive coating processes. The current collector 410 combined with the vent configuration allows for a lower, more tunable vent pressure as compared to other known vents. Additionally, the partial resealing achievable in the post vent state may limit the continued leakage of materials from the cell. It should further be appreciated that the vent arrangement eliminates the requirements for a thin vent portion as is commonly found in conventional collector and seal assemblies. Elimination of the thin vent region within a seal may reduce the manufacturing cost and enable use of stiffer plastics that may improve the sealing stress characteristics. It should be appreciated that the seal 430 may be made of strong materials, such as nylon, Noryl PXO 844, filled with PP, and other sufficiently strong materials that may eliminate the need for radial support provided by conventional spur, Belleville washer and neutral cover, thus resulting in a low profile design. Additionally, the seal material does not elongate to break to vent, such that more material options may be available. Further, it should be appreciated that the plated current collector 411 may be configured with an electroconductive plating that is broken when the seal 430 moves relative to the current collector 411 to the venting position, which may further reduce added gassing.

In yet a further embodiment, the current collector of the present invention is provided with a head or other portion having a mated junction or connection to the cover, such as a connector of a negative cover of an electrochemical cell. Such a mated junction allows greater contact area between the connector and current collector relative to the connection shown in FIGS. 4, 5 and 10-13 (wherein, respectively speaking, a non-welded connector 438 or a simple welded contact is utilized). Use of a mated junction instead of a fixed connection, such as welding, allows for more streamline and cost effective manufacturing processes insofar as a step can be eliminated. A mated junction will also increase contact surface area to prevent current from “burning through” or “punching through” the conductive plated layer on the surface of the current collector of the present invention. Such burning through is believed to occur because the concentrated flow of current over a small contact point can lead to resistive heating. In some cases, burn through can lead to disconnection of the circuit and failure of the cell.

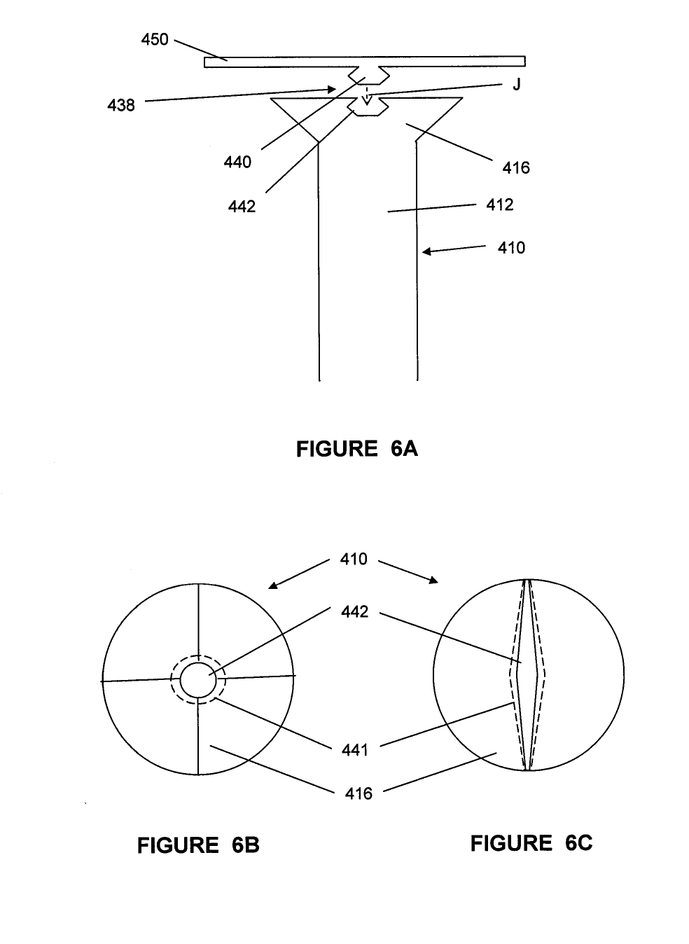

One possible embodiment for a mated junction is shown in FIG. 6A. The high surface area contact is attained by providing for a mated connection, press-fit as illustrated by arrow J. Connector 438 comprises of a projection 440 on negative cover 450 which mates with recess 442 in head 416 of current collector 410. Projection 440 in this case has a polygon-like shape, although any shape which allows for an interference fit could be utilized. Recess 442 is complimentary in shape to projection 440, allowing negative cover 450 to be press-fit into head 416 to form a mated junction. In a preferred embodiment, projection 440 has a hexagonal vertical (or axial relative to the cylinder of shaft 412) cross section and an essentially circular horizontal (or radial relative to the cylinder of shaft 412) cross section. This mated junction design could also be inverted so that the components and/or orientation of the above referenced elements could be interchanged.

FIG. 6B further illustrates a top view of an embodiment of a mated junction contemplated in FIG. 6A, but without illustrating negative cover 450. In FIG. 6B, recess 442 has a substantially cylindrical horizontal cross-section, wherein the diameter of the cross-section can vary along the height of the recess 442. FIG. 6B illustrates an example of a projection having an oval or circular horizontal/radial cross sectional shape (not shown in FIG. 6B) which fits into a corresponding recess 442 of current collector 410. The depth of the recess 442 must cooperate with the projection, although the three dimensional shape of projection 440 need not be regular or uniform (e.g., the projection/recess pairing can have a flat, sloped, curved, rounded and/or irregular bottom/top surface). Note that broken line 441 may represent the cross sectional diameter of the shaft 412. Alternatively or additionally, broken line 441 may also represent the outermost cross-sectional periphery of the shape used to create the interference press-fit for connector 438.

FIG. 6C illustrates a top view of an alternative embodiment. Here, recess 442 extends along the entire length across the top of head 416. In other embodiments, recess 442 could extend along a length which is less than the entire length of head 416 and/or in more than one direction (e.g., a cross shape, a Y-shape, a U-shape, etc.).

While the current collector has been described herein in connection with a cylindrical-type electrochemical cell, it should be appreciated that the invention concepts are likewise applicable to various other cell configurations including cells employing multiple anodes and multiple current collectors and cells in which the cans and current collectors are electrically connected to the negative and positive electrodes, respectively. Additionally, it should also be appreciated that the collector and seal assemblies described herein may be sealed closed against the steel can using various different can closures. Moreover, the current collector may alternately be configured in a primary or secondary cell.

In addition to reducing material cost and reducing the weight of an electrochemical cell utilized in the current collector of the present invention, the composite design can also reduce cell deep discharge gassing or leakage and, therefore, result in a more reliable cell design. It is known that prior art brass nails are oxidized during deep discharge and that the oxidized nail surface will form a galvanic couple with zinc to accelerate anode gassing. When a zinc plated composite current collector of the present invention is used to replace a brass nail, the zinc plating will be discharged or stripped during the deep discharge process. Consequently, the current collector will change back to an insulator, which will prevent the formation of a galvanic couple between the current collector and the zinc, and, therefore, reduce deep discharge gassing or leaking, or a combination thereof.

### EXAMPLE 1

The rod-shaped ABS plastic current collector, as shown in FIG. 1a, with the dimension of 0.091″ in diameter and 1.631″ in length was fabricated by injection molding. Plastic current collector was plated with copper by electroless plating and then electrolytic plating. The following pretreatment steps were taken prior to electroless plating. The parts were thoroughly rinsed in water after each following step.

Etching—ABS plastic current collector was etched in “chrome-sulfuric” etchant which contains 375 to 450 g/L chromium trioxide and 335 to 360 g/L sulfuric acid. The etching process was operated at 140 to 160° F. for 4-10 minutes.

Neutralizing—Plastic current collector was then put into a neutralizer consisted of 1 to 5% sodium bisulfite to eliminate excess etchant from the part by chemical reduction. Neutralizing process was operated at 92 to 132° F. for 1-4 minutes.

Activating—To provide catalytic sites on ABS plastic surface, the activation process was conducted at 40 to 104° F. for 5 to 10 minutes. The activator bath consists of the following: Stannous chloride (10˜20 g/L of solution), Palladium dichloride (0.2˜0.3 g/L) and Hydrochloric acid (˜200 mL/L)

Accelerating—To render the activating species deposited in the activating step as active as possible, the ABS plastic current collector was immersed in the activating solution consisted 80 to 120 mL/L Hydrochloric acid for 1 to 3 minutes at 95 to 104° F.

Pretreated ABS plastic collector was plated with copper by electroless plating to 1.5 um and then extended to 4.3 and 7.1 um by traditional electrolytic copper plating. As same as the brass current collector used, the copper plated ABS plastic collector was also chemically plated 0.02˜0.08 um tin outside of copper plating.

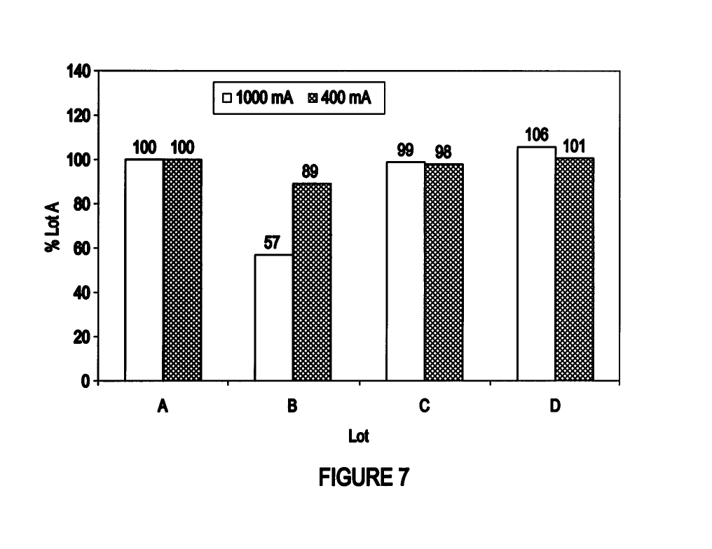

The copper plated ABS current collector was tested in C-size alkaline battery (LR14) and compared with rod-shaped tin plated brass current collector (0.072″ in diameter and 1.631″ in length). Cells were tested under 400 mA and 1000 mA continuous discharge to 0.9V cut-off at room temperature. The cell service data are presented in FIG. 7. Lot A in FIG. 7 stands for the cells with the brass current collector and, the Lots B, C, and D represent the cells constructed with the ABS plastic current collector with 1.5, 4.3 and 7.1 um copper plating respectively. The discharge capacity of Lot A was defined as 100% in FIG. 7 and the performances of cells from Lots B, C and D were then normalized to the performances of cells in Lot A. The data in FIG. 7 demonstrates that the equivalent performance of the brass current collector can be achieved when the copper plating thickness reaches or exceeds 4.3 um.

### EXAMPLE 2

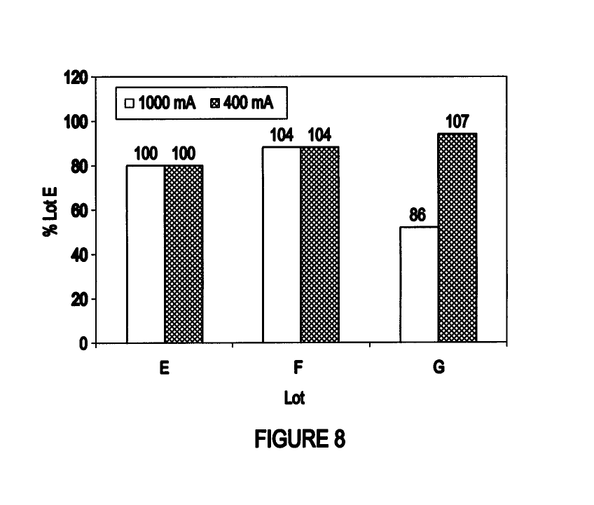

The rod-shaped ABS plastic current collectors shown in FIG. 1 a were electroless plated with about a 1 um copper film by using the same process mentioned in the example one above. They were subsequently electroplated with copper to 61 um or tin to 23 um respectively. Service evaluation was conducted in the same way as described above and data are summarized in FIG. 8. Lot E in FIG. 8 represents the cell constructed using a brass current collector and, the Lots F and G represent the cells constructed using an ABS plastic current collector with 61 um copper plating or 23 um tin plating respectively. For 400 mA discharge, both copper plated and tin plated ABS plastic collectors can match or exceed the brass collector on service. For 1000 mA, 23 um tin plated ABS collector shows a deficiency. Comparing FIG. 7 and FIG. 8, one can see that further increasing copper plating from 7.3 to 61 um did not show an apparent benefit for performances.

### EXAMPLE 3

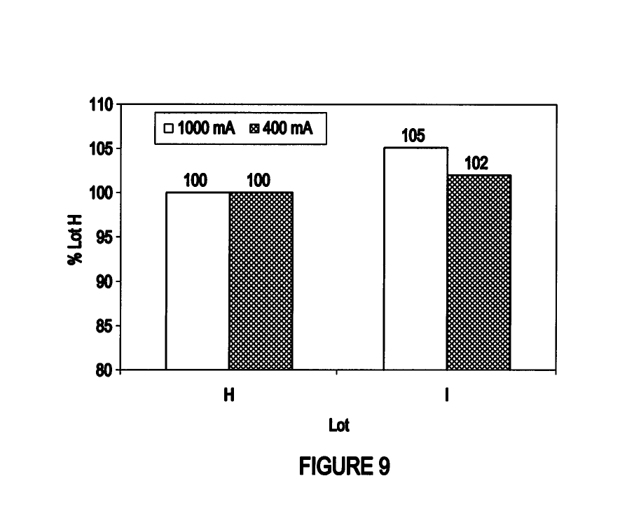

The step-shaped ABS plastic current collector, as shown in FIG. 1b, with the dimension of 0.071/0.051″ in diameters and 1.597″ in length was fabricated by injection molding. The collector was plated with 15.3 um copper plating using the same processes described in the example 1. The service was tested in C-size alkaline battery (LR14) and compared with rod-shaped tin plated brass current collector with the dimension of 0.046″ in diameter and 1.597″ in length. The Lot H in FIG. 9l represents the cell with the brass current collector and Lot I represent the cells constructed with the step-shaped ABS plastic current collector with 15.3 um copper plating. The copper plated step-shaped ABS plastic current collector shows equivalent or better performance than the brass collector.

It will be understood by those who practice the invention and those skilled in the art, that various modifications and improvements may be made to the invention without departing from the spirit of the disclosed concepts. The scope of protection afforded is to be determined by the claims and by the breadth of interpretation allowed by law.

What is claimed is:

1. An electrochemical cell, comprising:
a container comprising an open end and at least one contact terminal;
positive and negative electrodes disposed within the container; and
a current collector and seal assembly comprising:
a seal disposed in the open end of the container and having an opening and;
a current collector comprising an elongate member extending through the opening in the seal and disposed in contact with one of the positive and negative electrodes, said current collector comprising a non-conductive core and an electrically conductive outer surface, said elongate member having a first diameter portion sealingly engaging the opening of the seal in a non-vented state and a smaller second diameter portion configured to allow the seal to vent when exposed to an excessive pressure differential such that the seal moves relative to the current collector from a sealed engagement with the first diameter portion to a venting arrangement with the second diameter portion to vent high pressure gases.

2. The electrochemical cell as defined in claim 1, wherein the current collector further comprises a third diameter portion having a diameter greater than the first diameter portion and disposed between the first diameter portion and the second diameter portion.

3. The electrochemical cell as defined in claim 2, wherein the third diameter portion comprises a barb.

4. The electrochemical cell as defined in claim 1, wherein the seal comprises an annular seal having a central hub, wherein the opening is formed in the central hub.

5. The electrochemical cell as defined in claim 4, wherein the seal further comprises a peripheral portion having upstanding walls that are crimped by a portion of the container to close the open end of the container.

6. The electrochemical cell as defined in claim 1, wherein the elongate member of the current collector is substantially rod-shaped.

7. The electrochemical cell as defined in claim 1 further comprises a non-planar surface provided on at least one of an inner surface of the contact terminal and an upper surface of the seal so as to prevent resealing during cell venting.

8. The electrochemical cell as defined in claim 7, wherein the seal comprises one or more flutes formed in an upper surface of the seal to prevent resealing.

9. The electrochemical cell as defined in claim 1, wherein the current collector further comprises a head provided at one end and in electrical contact with the at least one contact terminal.

10. The electrochemical cell as defined in claim 1 further comprising a sealant disposed in the opening between the seal and the current collector.

11. The electrochemical cell as defined in claim 1, wherein an outer surface of the non-conductive core is completely covered by the conductive outer surface.

12. The electrochemical cell as defined in claim 1, wherein the conductive layer comprises an essentially non-carbonaceous conductive layer.

13. The electrochemical cell as defined in claim 1, wherein the current collector and seal assembly further comprises the contact terminal, wherein the contact terminal is in electrical and physical contact with the current collector.

14. The electrochemical cell as defined in claim 1 further comprising a conductive adhesive connecting the current collector to the contact terminal.

15. A current collector and seal assembly for an electrochemical cell, said assembly comprising:
a seal adapted to be disposed in an open end of a cell container and having an opening extending therethrough; and
a current collector comprising an elongate member extending through the opening in the seal and adapted to be disposed in contact with a cell electrode, the current collector comprising a non-conductive core and an electrically conductive outer surface, said elongate member comprising a first diameter portion sealingly engaging the opening of the seal in a non-vented state and a smaller diameter portion configured to allow the seal to vent when exposed to an excessive pressure differential such that the seal moves relative to the current collector from a sealed engagement with the first diameter portion to a venting arrangement with the second diameter portion to vent high pressure gases from a cell.

16. The current collector and seal assembly as defined in claim 15, wherein the current collector further comprises a third diameter portion having a diameter greater than the first diameter portion and disposed between the first diameter portion and the second diameter portion.

17. The current collector and seal assembly as defined in claim 16, wherein the third diameter portion comprises a barb.

18. The current collector and seal assembly as defined in claim 15, wherein the seal comprises an annular seal having a central hub, wherein the opening is formed in the central hub.

19. The current collector and seal assembly as defined in claim 18, wherein the seal further comprises a peripheral portion having an upstanding wall that is adapted to be crimped by a portion of a cell container to close an open end of the container.

20. The current collector and seal assembly as defined in claim 15, wherein the elongate member of the current collector is substantially rod-shaped.

21. The current collector and seal assembly as defined in claim 15, wherein the assembly further comprises a contact terminal electrically and physically connected to the current collector.

22. The current collector and seal assembly as defined in claim 21 further comprising a non-planar surface provided on at least one of an inner surface of the contact terminal and an upper surface of the seal so as to prevent resealing during the vent condition.

23. The current collector and seal assembly as defined in claim 22, wherein the seal comprises one or more flutes formed in an upper surface of the seal to prevent the resealing.

24. The current collector and seal assembly as defined in claim 21, wherein the contact terminal is electrically and physically connected to the current collector by way of a conductive adhesive.

25. The current collector and seal assembly as defined in claim 15, wherein an outer surface of the core is completely covered by the conductive outer surface.
